(19) United States
(12) Patent Application Publication
(10) Pub. No.: US 2026/0339190 A1
(43) Pub. Date: Oct. 29, 2026

(54) LAMINATED PANE HAVING A REFLECTIVE LAYER APPLIED IN A REGION

(71) Applicant: SAINT-GOBAIN SEKURIT FRANCE, THOUROTTE (FR)

(72) Inventors: Jan HAGEN, HERZOGENRATH (DE); Oliver GIER, HERZOGENRATH (DE)

(21) Appl. No.: 19/115,102

(22) PCT Filed: Sep. 15, 2023
(86) PCT No.: PCT/EP2023/075388

§ 371 Date: Mar. 25, 2025

(30) Foreign Application Priority Data
Sep. 26, 2022 (EP) 22197726.7

(51) Int. Cl. G03B 21/56; B32B 7/12; B32B 17/10; B60J 1/02; B60K 35/23; G02B 27/01

(52) U.S. Cl. CPC G03B 21/56; B32B 7/12; B32B 17/10036; B32B 17/10348; B32B 17/10541; B32B 17/10899; B60J 1/02; B60K 35/23; G02B 27/0101; B32B 2307/416; B32B 2307/7376; B32B 2605/00; B60K 2360/23; B60K 2360/25

(57) ABSTRACT

A laminated pane includes an outer pane, a thermoplastic intermediate layer, an inner pane, a masking layer in a region of the laminated pane, an adhesive layer, and a glass pane having an outer-side and interior-side surfaces and a thickness of 20 μm to 300 μm. The thermoplastic intermediate layer is between the outer and inner panes, the adhesive layer is between the inner and glass panes, a reflective layer for reflecting light is arranged on the outer-side surface of the glass pane and/or on the interior-side surface of the glass pane, and the glass pane is in a region of the laminated pane which, in a perpendicular view through the laminated pane, lies entirely within the region in which the masking layer is arranged.

The invention relates to a laminated pane having a reflective layer applied in a region, a method for the production and use thereof, and to a projection arrangement.

Modern automobiles are increasingly equipped with so-called head-up displays (HUD's). With a projector, typically in the area of the dashboard, images are projected onto the windshield, reflected there, and perceived by the driver as a virtual image behind the windshield (as seen by the driver). Thus, important information can be projected into the field of vision of the driver, for example, the current travel speed, navigation messages or warnings that the driver can perceive without having to turn his gaze away from the road. Head-up displays can accordingly contribute substantially to increasing traffic safety.

However, head-up displays often have the problem that the region of the windshield which is provided for reflection of the light projected by the projector has to have a high transparency of generally at least 70%. The reflected light of the projector is thus overlaid with light from the external environment, which, depending on the light conditions, can lead to a reduction in contrast of the virtual image and thus to a poorer visual perception for the driver. A sufficient visual perception of, in particular, safety-relevant information such as lane assistance, speed display or rotational speed of the motor should be ensured in all weather and light conditions. It would thus be desirable to have a projection arrangement which is based on the head-up display technology in which no undesired secondary images occur and the arrangement of which is relatively easy to accomplish with good visibility with sufficient brightness and contrast of the displayed image information. In order to achieve this, it is necessary to increase the contrast in the reflection region of the windshield. The contrast increase can be achieved, for example, by the background of the reflection region being largely or completely opaque. However, such solutions require that a reflective layer is applied only in a locally limited region of the windshield.

A reflective layer is usually applied to glass panes by means of physical vapor deposition (PVD), for example by cathode sputtering, in particular by magnetic field-assisted cathode sputtering (“magnetron sputtering”). Cold gas spraying is also a suitable method for coating glass panes and is a coating method that is generally known to those skilled in the art.

WO 2019/186495 A1 discloses a sheet of laminated glass having at least one step-shaped functional portion comprising two stacks of components—the main stack of components in which changes to its properties are not desired, and a second component stack comprising a functional layer. The functional layer can be selected from the group consisting of switchable film, switchable layers, displays, lighting means, touch-sensitive layers, sensor layers, light sensors, acoustic sensors, acoustic PVB layers, heat-reflecting films and heat-absorbing films.

In the publication “Glass meets flexibility: Challenges in manufacturing of thin films on flexible glass” by M. Junghähnel et al., published in Vacuum in Research and Practice, vol. 26, no. 5, pp. 35-39, the production of thin films on flexible glass is discussed.

WO 2022/161894 A1 describes a vehicle window for a head-up display, comprising at least one transparent pane and at least one masking strip in the edge region of the pane, wherein the masking strip is arranged on or in a carrier film, the carrier film is joined to the transparent pane and a light-directing device or an image display device is arranged in the region of the first masking strip on the side of the masking strip facing the vehicle interior. The light-directing device can, for example, be a holographic light-directing device with at least one holographic optical element suitable for directing light, which is designed such that incident light is directed in the direction of the vehicle interior.

The object of the present invention is to provide an improved laminated pane having a reflective layer applied in a region. In particular, the laminated pane is intended to be easy to produce and the occurrence of ghost images is intended to be avoided.

The object of the present invention is achieved according to the invention by a laminated pane according to claim 1. Preferred embodiments are apparent from the dependent claims.

The laminated pane according to the invention comprises an outer pane, a thermoplastic intermediate layer, a masking layer, an inner pane, an adhesive layer and a glass pane. The thermoplastic intermediate layer is arranged between the outer pane and the inner pane, and the adhesive layer is arranged between the inner pane and the glass pane. According to the invention, the masking layer is arranged in a region of the laminated pane and the glass pane is arranged in a region of the laminated pane which, when looking perpendicularly through the laminated pane, lies entirely within the region in which the masking layer is arranged.

The laminated pane is provided to separate the interior from the external environment in a window opening of a vehicle. Within the meaning of the invention, the term “inner pane” refers to the pane of the laminated pane facing the vehicle interior. Outer pane means the pane facing the external environment.

The laminated pane has in particular an upper edge and a lower edge and two side edges extending between them. Upper edge means the edge intended to point upwards in the installed position. Lower edge means the edge intended to point downward in the installed position. In the case of a windshield, the upper edge is often also referred to as the roof edge and the lower edge is referred to as the motor edge.

The outer pane, the inner pane and the glass pane in each case have an outer-side and an interior-side surface and a circumferential side edge extending between them. In the sense of the invention, the outer-side surface means the main surface which is intended to face the external environment when installed. In the sense of the invention, the interior-side surface means the main surface which is intended to face the interior when installed. The interior-side surface of the outer pane and the outer-side surface of the inner pane face one another and are joined to one another by the thermoplastic intermediate layer.

The outer-side surface of the outer pane is designated as side I. The interior-side surface of the outer pane is designated as side II. The outer-side surface of the inner pane is designated as side III. The interior-side surface of the inner pane is designated as side IV. The outer-side surface of the glass pane is designated as side V. The interior-side surface of the glass pane is designated as side VI.

It should be understood that the inner pane is arranged between the outer pane and the glass pane. The interior-side surface of the outer pane and the outer-side surface of the inner pane face one another. The interior-side surface of the inner pane and the outer-side surface of the glass pane face one another.

According to the invention, the glass pane has a thickness of 20 μm (micrometers) to 300 μm. The glass pane is therefore made of ultra-thin glass. Such a pane consisting of ultra-thin glass is flexible and can be adapted to the curvature of a window.

In addition, according to the invention a reflective layer for reflecting light is arranged on the outer-side surface of the glass pane and/or on the interior-side surface of the glass pane.

The reflective layer thus has a smaller distance to the vehicle interior than the masking layer when the laminated pane is installed in a vehicle.

According to the invention, the adhesive layer is either formed as an opaque adhesive layer or the adhesive layer is formed as an opaque adhesive layer or a colorless adhesive layer and an opaque layer is arranged between the adhesive layer and the glass pane so as to be immediately adjacent to the adhesive layer.

In one embodiment, the adhesive layer is thus formed as an opaque adhesive layer and no opaque layer is arranged between the adhesive layer and the glass pane so as to be immediately adjacent to the adhesive layer.

In an alternative embodiment, the adhesive layer is thus formed as a colorless adhesive layer and an opaque layer is arranged between the adhesive layer and the glass pane so as to be immediately adjacent to the adhesive layer.

In an alternative embodiment, the adhesive layer is thus formed as an opaque adhesive layer and an opaque layer is arranged between the adhesive layer and the glass pane so as to be immediately adjacent to the adhesive layer.

The opaque layer is preferably black. The opaque adhesive layer is preferably colored black.

Due to the fact that the glass pane is arranged in a region of the laminated pane which, in a perpendicular view through the laminated pane, lies entirely within the region in which the masking layer is arranged, the reflective layer applied to the glass pane is also arranged in a region which, in a perpendicular view through the laminated pane, lies entirely within the region in which the masking layer is arranged. The reflective layer is therefore arranged in a perpendicular view through the laminated pane or in an orthogonal projection through the laminated pane so as to cover or overlap with the masking layer. The reflective layer thus does not have a portion which does not cover the masking layer, i.e., the reflective layer is formed only where it is in front of the masking layer when viewing the inside of the laminated pane.

In addition, because the adhesive layer is formed as an opaque adhesive layer and/or an opaque layer is arranged between the adhesive layer and the glass pane so as to be immediately adjacent to the adhesive layer, the reflective layer applied to the glass pane is arranged so as to overlap with the opaque adhesive layer or the opaque layer when looking perpendicularly through the laminated pane or projecting orthogonally through the laminated pane. The reflective layer is therefore only formed where it is located in front of the opaque adhesive layer or in front of the opaque layer when looking at the inside of the laminated pane. The opaque adhesive layer and/or the opaque layer prevent ghost images that could arise on the interior-side surface of the inner pane, on the outer-side surface of the inner pane, on the interior-side surface of the outer pane and/or on a surface of a layer arranged between the inner pane and the outer pane.

In a preferred embodiment of the laminated pane according to the invention, the glass pane has a thickness of from 50 μm to 200 μm, particularly preferably from 50 μm to 100 μm, for example 70 μm or 100 μm.

As described above, the reflective layer is a reflective layer for reflecting light. The reflective layer is preferably opaque or partially transparent, which means within the context of the invention that the average transmission thereof (according to ISO 9050:2003) in the visible spectral range is preferably at most 90%, particularly preferably at most 80%, very particularly preferably at most 50% and in particular less than 10%. The reflective layer preferably reflects at least 10%, particularly preferably at least 25%, of the light impinging upon the reflective layer. This quantity is also called reflectance. The reflective layer preferably reflects p-polarized and s-polarized light to varying degrees.

The light reflected by the reflective layer is preferably visible light, i.e., light in a wavelength range of approximately 380 nm to 780 nm. The reflective layer preferably has high and uniform reflectance (across different angles of incidence) with respect to p-polarized and s-polarized radiation, so as to ensure that a high-intensity and color-neutral image is presented.

The indication of the polarization direction refers to the plane of incidence of the radiation on the laminated pane. P-polarized radiation refers to a radiation the electric field of which oscillates in the plane of incidence. S-polarized radiation refers to a radiation the electric field of which oscillates perpendicular to the plane of incidence. The plane of incidence is spanned by the incident vector and the surface normal of the laminated pane in the geometric center of the irradiated region.

In other words, the polarization, i.e., in particular, the proportion of p- and s-polarized radiation, is determined at a point of the region irradiated by the image display device, preferably in the geometric center of the irradiated region. Since laminated panes can be curved (for example, when configured as a windshield), which has effects upon the plane of incidence of the radiation, polarization components slightly deviating therefrom can occur in the other regions, which is unavoidable for physical reasons.

The reflectance describes the proportion of the total irradiated radiation within the given spectral range that is reflected. The reflectance always refers to a specific spectral range, for example the visible spectral range from 380 nm to 780 nm or, for example, the ultraviolet range. It is indicated in % (based upon 100%-emitted radiation) or as a unitless number from 0 to 1 (normalized to the emitted radiation). It forms the reflection spectrum when plotted as a function of the wavelength. The information on the reflectance or the reflection spectrum relates to a reflection measurement with a light source which radiates uniformly in the observed spectral range with a normalized radiation intensity of 100%.

The term “reflectance” is used in the sense of the standard DIN EN 410-2011-04. Reflectance always refers to the reflectance on the layer side, which is measured when the substrate provided with the coated regions, here the glass pane arranged on the inner pane, is facing the light source and the detector. Transparent elements, such as the glass pane, can be interposed to separate the coated substrate from the light source and the detector.

The reflectance is measured at an angle of incidence of 8° (unless otherwise stated) to the coated surface normal. The spectral range of from 380 nm to 800 nm was used to characterize the reflective properties.

In a preferred embodiment of the invention, the reflective layer contains or consists of a dielectric layer and/or a metal layer. In a particularly preferred embodiment, the reflective layer is a metal layer. In another preferred embodiment, the reflective layer is a dielectric layer.

In a very particularly preferred embodiment, the reflective layer is a layer stack consisting of a metal layer and a dielectric layer, wherein the dielectric layer is preferably located behind the metal layer when looking at the inside of the laminated pane. A reflective layer formed as a layer stack consisting of a metal layer and a dielectric layer has higher reflectivity to visible light than a reflective layer formed as a dielectric layer or metal layer.

The dielectric layer can be a layer made up of one or more layers and can have or consist of at least one highly refractive layer with a refractive index greater than 1.9.

Preferably, the highly refractive layer is formed on the basis of silicon nitride, tin-zinc oxide, silicon zirconium nitride, silicon aluminum nitride, silicon titanium nitride, silicon hafnium nitride, or titanium oxide, with it particularly preferably being based on titanium oxide.

The dielectric layer preferably has a thickness of 1 nm (nanometers) to 120 nm, particularly preferably of 40 nm to 80 nm, very particularly preferably of 50 nm to 70 nm.

The metal layer preferably contains or consists of at least one metal selected from a group consisting of zirconium, hafnium, silver, gold, nickel, chromium, molybdenum, tungsten, copper, vanadium, niobium, tantalum, palladium, platinum, titanium, zinc, tin or aluminum or alloys thereof.

The metal layer preferably has a thickness of 1 nm to 100 nm, particularly preferably of 5 nm to 50 nm, in particular of 8 nm to 15 nm.

Methods for measuring the thickness of the dielectric layer and the thickness of the metal layer are known to those skilled in the art. The thicknesses can be determined using common methods for determining the layer thickness of thin films, for example spectroscopic reflectometry, confocal microscopy, white light interferometry or ellipsometry. These methods enable non-destructive measurement, with corresponding measuring equipment being commercially available. Ellipsometers are commercially available, for example from Sentech. White light interferometry, profilometry, for example confocal profilometry, or ellipsometry are preferably used.

In a particularly preferred embodiment of the laminated pane according to the invention, the reflective layer for reflecting light is arranged on the outer-side surface of the glass pane. In this embodiment a reflective layer is therefore not arranged on the interior-side surface of the glass pane. This embodiment offers, among other things, the advantage that a reflective layer arranged in this way is joined to the inner pane via the adhesive layer or an opaque layer is arranged on a reflective layer arranged in this way and the reflective layer is thus protected.

In a preferred embodiment of the laminated pane according to the invention, a reflective layer for reflecting light is arranged on the interior-side surface of the glass pane and a protective layer is preferably arranged on this reflective layer. In this embodiment, there is no reflective layer arranged on the outer-side surface of the glass pane.

In a further preferred embodiment of the laminated pane according to the invention, a reflective layer for reflecting light is arranged both on the interior-side surface of the glass pane and on the outer-side surface of the glass pane, and a protective layer is preferably arranged on the reflective layer that is arranged on the interior-side surface of the glass pane. No protective layer is necessary for the reflective layer arranged on the outer-side surface of the glass pane, since this reflective layer is joined to the inner pane via the adhesive layer or an opaque layer is arranged on this reflective layer, and this reflective layer is thus protected. Optionally, a protective layer can, however, also be arranged on the reflective layer arranged on the outer-side surface of the glass pane.

The protective layer is preferably transparent and applied in a planar manner, in particular congruently, on the reflective layer. The protective layer is preferably a polymer based on polyacrylates, polyoximes, alkyd resins, polyurethanes or mixtures thereof. The protective layer preferably has a thickness of 50 nm to 10 μm and particularly preferably of 100 nm to 5 μm.

The protective layer protects the reflective layer from mechanical damage, such as scratches. It can also serve to increase the durability of the reflective layer. As a result of the protective layer, fewer particles separate from the reflective layer in a time-resolved manner and the reflective layer retains its shape for longer.

In a particularly preferred embodiment of the invention, the protective layer is a layer that is easy to clean and/or an “anti-fingerprint” layer. For the purposes of the invention, “layer that is easy to clean” means that dirt in the form of, for example, fingerprints, grease spots and dirt particles on the protective layer can be removed from the protective layer by using a cloth and preferably a microfiber cloth. Grease-dissolving or abrasive cleaning agents and solvents, for example based on alcohols, are therefore largely avoided for the cleaning of the protective layer. For the purposes of the invention, “anti-fingerprint” means a layer in which fingerprints that adhere to the protective layer are hardly or not at all perceptible visually. The term “fingerprints” refers in particular to the grease-containing components of a human finger that remain on a surface when a surface is touched and can be unaesthetic.

As described above, in the laminated pane according to the invention, a masking layer is arranged in a region of the laminated pane. The masking layer is preferably arranged in an edge region of the laminated pane, which is typically adjacent to the pane edge of the pane. The great advantage of this arrangement is obtained when the laminated pane in a vehicle is used as a windshield, because the masking layer when arranged in an edge region lies outside the main viewing region of the driver.

The masking layer is preferably arranged at least along the lower edge and adjacent to the lower edge. This results in a rectangular opaque strip, which is arranged along the lower edge, when looking onto the laminated pane.

In a particularly preferred embodiment of the laminated pane according to the invention, the masking layer is designed to run peripherally in a frame-like manner. In a portion in which the glass pane and thus also the reflective layer applied thereon is arranged overlapping the masking layer, the frame-like masking layer is preferably provided with a widening, i.e., it has a greater width (dimension perpendicular to the extension) than in other portions. In this way, the masking layer can be adapted in a suitable manner to the dimensions of the glass pane with the reflective layer applied thereto.

In one embodiment, the masking layer is thus designed to extend peripherally in the manner of a frame and, in particular in a portion which overlaps with the glass pane, has a greater width than in portions that are not this portion.

The glass pane with the reflective layer applied thereto preferably has substantially the shape of a rectangle which extends between the two side edges in a region near the lower edge. Particularly preferably, the edges of the glass pane do not reach the side edges and the lower edge, but instead are, for example, 2 cm to 5 cm distant from them.

The masking layer within the meaning of the invention is a layer that prevents the possibility of looking through the laminated pane. In this case, at most 5%, preferably at most 2%, particularly preferably at most 1%, in particular at most 0.1%, of the light of the visible spectrum is transmitted through the masking layer. The masking layer is thus an opaque masking layer, preferably a black masking layer.

The masking layer is preferably a coating made up of one or more layers. Alternatively, the masking layer can also be a colored region of the thermoplastic intermediate layer. According to a preferred embodiment of the laminated pane, the masking layer consists of a single layer. This has the advantage of a particularly simple and cost-effective manufacture of the laminated pane because only a single layer has to be formed for the masking layer.

The masking layer is in particular an opaque masking print made of a dark, preferably black, enamel.

In a preferred embodiment, the masking layer is designed as an opaque masking print arranged on the interior-side surface of the outer pane, in particular made of a dark, preferably black, enamel.

In an alternative preferred embodiment, the masking layer is formed as an opaque masking print arranged on the outer-side surface of the inner pane, in particular made of a dark, preferably black, enamel.

In an alternative preferred embodiment, the masking layer is formed as an opaque region of the thermoplastic intermediate layer.

In one embodiment, the thermoplastic intermediate layer is formed in one piece and is opaquely colored in a region.

An opaque masking layer formed as an opaquely colored region of the thermoplastic intermediate layer can also be realized by using a thermoplastic intermediate layer composed of an opaque thermoplastic film and a transparent thermoplastic film. The opaque thermoplastic film and transparent thermoplastic film are preferably arranged offset from one another, so that the two films are not overlapping when viewed through the laminated pane. The transparent and the opaque film consist of the same plastics or preferably contain the same plastics. The materials on the basis of which the opaque film and the transparent film can be formed are those which are also described for the thermoplastic intermediate layer. The opaque film is preferably a colored film which can have different colors, in particular black.

The laminated pane according to the invention can also have an additional opaque masking print that is arranged on the interior-side surface of the inner pane, in particular at least in the region where the glass pane is arranged. Such an additional masking print on the interior-side surface of the inner pane improves the adhesion properties between the surface and an adhesive layer. The additional opaque masking print is preferably designed in the shape of a frame.

The adhesive layer is preferably a thermoplastic layer or an adhesive. As described above, the adhesive layer is formed as an opaque adhesive layer if no opaque layer is arranged between the adhesive layer and the glass pane so as to be immediately adjacent to the adhesive layer, and the adhesive layer is formed as an opaque or a colorless adhesive layer if an opaque layer is arranged between the adhesive layer and the glass pane so as to be immediately adjacent to the adhesive layer.

An opaque adhesive layer can thus preferably be formed as an opaque thermoplastic layer or an opaque adhesive and a colorless adhesive layer can preferably be formed as a colorless thermoplastic layer or an optical clear adhesive.

Suitable opaque adhesives and suitable optical clear adhesives (OCAs) are known to those skilled in the art.

A colorless adhesive layer formed as a thermoplastic layer contains at least one thermoplastic polymer, preferably ethylene vinyl acetate (EVA), polyvinyl butyral (PVB) or polyurethane (PU), or mixtures, or copolymers, or derivatives thereof, particularly preferably PVB. The thermoplastic layer is typically formed from a thermoplastic film (joining film). The thickness of the thermoplastic layer is preferably from 0.2 mm to 2 mm, particularly preferably from 0.3 mm to 1 mm, for example 760 μm. The thermoplastic polymer layer can be formed by a single film or also by more than one film. A thermoplastic layer formed as an opaque thermoplastic layer additionally contains pigments.

Suitable opaque thermoplastic layers are known to those skilled in the art.

The opaque layer can be formed as an opaque coating arranged directly or indirectly on the outer-side surface of the glass pane. In embodiments in which the laminated pane has an opaque layer and the reflective layer is arranged only on the interior-side surface of the glass pane, the opaque layer is formed as a coating arranged directly on the outer-side surface of the glass pane. In embodiments in which the laminated pane has an opaque layer and a reflective layer is arranged on the outer-side surface of the glass pane, the opaque layer is formed as a coating on the reflective layer arranged on the outer-side surface of the glass pane, i.e., the opaque layer is formed in these embodiments as a coating arranged indirectly on the outer-side surface of the glass pane.

An opaque adhesive layer within the meaning of the invention is an adhesive layer that prevents the possibility of looking through the laminated pane. In this case, at most 5%, preferably at most 2%, particularly preferably at most 1%, in particular at most 0.1%, of the light of the visible spectrum is transmitted through the opaque adhesive layer.

An opaque layer within the meaning of the invention is a layer that prevents the possibility of looking through the laminated pane. In this case, at most 5%, preferably at most 2%, particularly preferably at most 1%, in particular at most 0.1%, of the light of the visible spectrum is transmitted through the opaque layer.

In one embodiment, the laminated pane additionally comprises an HUD layer arranged between the outer pane and the inner pane.

The principle of a head-up display (HUD) and the technical terms used herein in the field of HUDs are generally known to a person skilled in the art. For a detailed depiction, reference is made to the dissertation, “Simulation-based measurement technique for testing head-up displays”, by Alexander Neumann of the Institute for Informatics of the Technical University of Munich (Munich: University Library of TU Munich, 2012)—in particular, to Chapter 2, “The Head-Up Display”. The HUD layer is arranged between the outer pane and the inner pane, with “between” being able to mean both within the thermoplastic intermediate layer and in direct spatial contact on the interior-side surface of the outer pane and on the outer-side surface of the inner pane. The HUD layer is suitably designed to reflect p-polarized light. The HUD layer is a reflective coating which is introduced over a large area of the laminated pane, wherein the region in which the HUD coating is located is also referred to as the HUD region. To use the laminated pane as a head-up display, a projector is directed onto the HUD region of the laminated pane. The radiation of the projector is preferably predominantly p-polarized. The HUD layer is suitable for reflecting p-polarized radiation. As a result, a virtual image is generated from the projector radiation which the driver of a vehicle can perceive behind the laminated pane.

The HUD layer preferably comprises at least one metal selected from the group consisting of aluminum, tin, titanium, copper, chromium, cobalt, iron, manganese, zirconium, cerium, yttrium, silver, gold, platinum, and palladium, or mixtures thereof. In a preferred embodiment, the HUD layer is a coating containing a thin-film stack, i.e., a sequence of thin individual layers. This thin-film stack contains one or more electrically conductive layers on the basis of silver. The electrically conductive layer based on silver provides the HUD layer with basic reflective properties and also an IR-reflecting effect and electrical conductivity. The conductive layer preferably contains at least 90 wt % silver, particularly preferably at least 99 wt % silver, and very particularly preferably at least 99.9 wt % silver. The silver layer can have dopants, e.g., palladium, gold, copper, or aluminum. Materials on the basis of silver are particularly suitable for reflecting p-polarized light. The HUD layer has a thickness of from 5 nm to 50 nm, and preferably from 8 nm to 25 nm.

The HUD layer may also be designed as a reflective film which reflects p-polarized light. The HUD layer may be a carrier film with a reflective coating, or a reflective polymer film. The reflective coating preferably comprises at least one layer on the basis of a metal and/or a dielectric layer sequence with alternating refractive indices. The layer on the basis of a metal preferably contains or consists of silver and/or aluminum. The dielectric layers can be formed, for example, on the basis of silicon nitride, zinc oxide, tin-zinc oxide, silicon-metal mixed nitrides, such as silicon-zirconium nitride, zirconium oxide, niobium oxide, hafnium oxide, tantalum oxide, or silicon carbide. The oxides and nitrides mentioned can be deposited stoichiometrically, substoichiometrically, or hyperstoichiometrically. They can have dopings, e.g., aluminum, zirconium, titanium, or boron. The reflective polymer film preferably comprises or consists of dielectric polymer layers. The dielectric polymer layers preferably contain PET. If the HUD layer is designed as a reflective film, it is preferably 30 μm to 300 μm, particularly preferably 50 μm to 200 μm, and in particular 100 μm to 150 μm, thick. According to a further preferred embodiment, the HUD layer is designed as a reflective film and is arranged within the thermoplastic intermediate layer.

The laminated pane is preferably curved in one or more spatial directions, as is usual for motor vehicle panes, wherein the typical radii of curvature are in a range of approximately 10 cm to approximately 40 m. However, the laminated pane can also be flat, for example if it is provided as a pane for buses, trains or tractors.

The thermoplastic intermediate layer, via which the outer pane is joined to the inner pane, comprises at least one thermoplastic polymer, preferably ethylene vinyl acetate (EVA), polyvinyl butyral (PVB) or polyurethane (PU), or mixtures, or copolymers or derivatives thereof, particularly preferably PVB. The thermoplastic intermediate layer is typically formed from a thermoplastic film (joining film). The thickness of the thermoplastic intermediate layer is preferably from 0.2 mm to 2 mm, particularly preferably from 0.3 mm to 1 mm, for example 760 μm. The thermoplastic intermediate layer can be formed by a single film or also by more than one film. The thermoplastic intermediate layer can also be a film with functional properties, for example a film with acoustic damping properties.

The outer pane and the inner pane preferably contain or consist of glass, particularly preferably flat glass, float glass, quartz glass, borosilicate glass, soda lime glass, alumino silicate glass, or clear plastics, preferably rigid clear plastics, in particular polyethylene, polypropylene, polycarbonate, polymethyl methacrylate, polystyrene, polyamide, polyester, polyvinyl chloride, and/or mixtures thereof.

The outer pane and the inner pane can be clear and colorless, but also tinted or colored. In a preferred embodiment, the total transmission through the windshield is greater than 70% in the main see-through region (light type A). The term “total transmission” relates to the method defined by ECE-R 43, Annex 3, § 9.1 for testing the light transmittance of motor vehicle panes. Independently of one another, the outer pane and the inner pane can be non-tempered, partially tempered or tempered. If at least one of the panes is to be tempered, this can be thermal or chemical prestressing.

The thickness of the outer pane and of the inner pane can vary widely and accordingly be adapted to the requirements in the individual case. The outer pane and the inner pane preferably have thicknesses of 0.5 mm to 5 mm, particularly preferably of 1 mm to 3 mm, very particularly preferably of 1.6 mm to 2.1 mm. For example, the outer pane has a thickness of 2.1 mm, and the inner pane has a thickness of 1.6 mm. However, the outer pane or, in particular, the inner pane can also be thin glass with a thickness of 0.55 mm, for example.

The glass pane preferably contains or consists of alumino-silicate glass, borosilicate glass, alumino-borosilicate glass. The glass pane can be non-tempered, partially tempered or tempered.

The laminated pane according to the invention can comprise one or more additional intermediate layers, in particular functional intermediate layers, between the outer pane and the inner pane. An additional intermediate layer can be, in particular, an intermediate layer with acoustically damping properties, an intermediate layer reflecting infrared radiation, an intermediate layer absorbing infrared radiation, an intermediate layer absorbing UV radiation, a layer that is colored at least in portions and/or an intermediate layer that is tinted at least in portions. If there is a plurality of additional intermediate layers, they can also have different functions.

In the context of the present invention, refractive indices are in all cases specified in relation to a wavelength of 550 nm. Unless otherwise indicated, the specification of layer thicknesses or thicknesses refers to the geometric thickness of a layer.

The invention also relates to a projection arrangement at least comprising a laminated pane according to the invention and an imaging unit directed at the reflective layer.

Also according to the invention, therefore, is a projection arrangement at least comprising:
a laminated pane at least comprising an outer pane having an outer-side surface and an interior-side surface, a thermoplastic intermediate layer, an inner pane having an outer-side surface and an interior-side surface, a masking layer arranged in a region of the laminated pane between the outer pane and the inner pane, an adhesive layer and a glass pane having an outer-side surface and an interior-side surface and a thickness of 20 μm to 300 μm,
wherein the thermoplastic intermediate layer is arranged between the outer pane and the inner pane, the adhesive layer is arranged between the inner pane and the glass pane, a reflective layer for reflecting light is arranged on the outer-side surface of the glass pane and/or on the interior-side surface of the glass pane,
and wherein the glass pane is arranged in a region of the laminated pane which, when viewed perpendicularly through the laminated pane, lies completely within the region in which the masking layer is arranged,
and wherein the adhesive layer is formed as an opaque adhesive layer or the adhesive layer is formed as an opaque adhesive layer or a colorless adhesive layer and an opaque layer is arranged between the adhesive layer and the glass pane so as to be immediately adjacent to the adhesive layer.
and an imaging unit directed at the reflective layer.

Preferably, a reflective layer is only arranged on the outer-side surface of the glass pane.

In particular, in a projection arrangement according to the invention, the combination of the reflective layer with the masking layer that is arranged therebehind from a vehicle occupant's perspective and the opaque adhesive layer and/or opaque layer brings about good visibility of the image, even in the case of external solar radiation and when low-light-intensity imaging units are used. Even under these circumstances, the image generated by the imaging unit appears bright and can be seen perfectly. This enables a reduction in the power of the imaging unit and thus a reduced energy consumption.

From a vehicle occupant's perspective, the reflective layer is arranged spatially in front of the masking layer and spatially in front of the opaque adhesive layer and/or the opaque layer when looking through the inner pane. As a result, the region of the laminated pane in which the reflective layer is arranged appears opaque. The expression “when looking through the laminated pane” means looking through the laminated pane from the interior. Within the context of the present invention, “spatially in front of” means that the reflective layer is arranged spatially further away from the outer-side surface of the outer pane than the masking layer and is arranged spatially further away from the outer-side surface of the outer pane than the opaque adhesive layer and/or the opaque layer. Preferably, the masking layer is a peripheral masking layer and widens at least in the region which overlaps with the reflective layer and in which the laminated pane is used for displaying images. This means that when viewed perpendicular to the closest portion of the peripheral edge of the laminated pane, the masking layer in this region has a greater width than in other portions. In this way, the masking layer can be adapted to the dimensions of the reflective layer.

The imaging unit of the projection arrangement emits light and is arranged in the vicinity of the interior-side surface of the laminated pane such that the imaging unit irradiates this surface, wherein the light is reflected by the reflective layer of the laminated pane. The reflective layer preferably reflects at least 10%, particularly preferably at least 25% of the light impinging on the reflective layer that is in a wavelength range of from 400 nm to 700 nm and at angles of incidence of 55° to 80°. This is advantageous in order to achieve the greatest possible brightness of an image emitted by the imaging unit and reflected on the reflective layer.

The imaging unit serves to emit an image and can thus also be referred to as a projector, display device or image display device. A display or other device known to a person skilled in the art, for example, can be used as the imaging unit. The imaging unit is preferably a display, particularly preferably an LCD display, LED display, OLED display or electroluminescent display, in particular an LCD display. Displays have a low installation height and are thus simply integrated into the dashboard of a vehicle in a space-saving manner. Moreover, displays can be operated in a significantly more energy-saving manner than other imaging units. The comparatively lower brightness of displays is completely sufficient here in the combination according to the invention of the reflective layer and with the mask layer located behind it. The radiation of the imaging unit preferably impinges in the region of the reflective layer at an angle of incidence of 55° to 80°, preferably of 62° to 77° on the laminated pane. The angle of incidence is the angle between the incidence vector of the radiation of the image display device and the surface normal in the geometric center of the reflective layer.

In a projection arrangement having a reflective layer applied to the interior-side surface of the glass pane, the desired virtual image is created by reflection from the reflective layer and no ghost image occurs.

In a projection arrangement having a reflective layer applied to the outer-side surface of the glass pane, the desired virtual image is generated by reflection at the reflective layer and, in addition, a second virtual image, the so-called ghost image or ghost, is generated by reflection at the interior-side surface of the glass pane.

In a projection arrangement having a reflective layer applied to the outer-side surface of the glass pane and a reflective layer applied to the interior-side surface of the glass pane, a first virtual image is generated by reflection on the reflective layer applied to the outer-side surface of the glass pane and in addition a second virtual image is generated on the reflective layer applied to the interior-side surface of the glass pane.

However, with the small thicknesses for the glass pane according to the invention, the spatial offset between the first virtual image and the ghost image or between the first virtual image and the second virtual image is sufficiently small so as not to be disturbing. The effect is based on the typical angular visual acuity of the human eye: the thin glass pane according to the invention leads to an offset between the first virtual image and the ghost image or between the first virtual image and the second virtual image, which can no longer be resolved by the human eye.

In preferred embodiments of the projection arrangement according to the invention, the imaging unit emits s-polarized radiation and p-polarized radiation in a ratio of between 1:10 and 10:1 or the imaging unit emits circularly polarized radiation.

In one embodiment, the imaging unit has a λ/2 waveplate, by means of which the ratio of the s-polarized radiation and p-polarized radiation emitted by the imaging unit onto the reflective layer can be varied. For example, the proportion of p-polarized radiation can be increased if the driver is wearing polarization-selective sunglasses and the proportion of s-polarized radiation can be increased if the driver is not wearing polarization-selective sunglasses.

The projection arrangement according to the invention is particularly suitable for combination with an HUD layer. In this case, the laminated pane has an HUD layer as described above in an embodiment of the laminated pane according to the invention, which is arranged between the outer pane and the inner pane. In this embodiment, the masking layer and thus also the glass pane comprising the reflective layer and the opaque adhesive layer or the opaque layer are only locally limited to the edge region of the laminated pane and therefore do not influence the HUD layer applied in the see-through region of the laminated pane.

The preferred embodiments of the laminated pane according to the invention described above also correspondingly apply for the projection arrangement according to the invention comprising a laminated pane according to the invention and an imaging unit and vice versa.

According to the invention a method for producing a laminated pane according to the invention comprises at least:
a) providing a laminate consisting of an outer pane having an outer-side surface and an interior-side surface, a thermoplastic intermediate layer and an inner pane having an outer-side surface and an interior-side surface, wherein the thermoplastic intermediate layer is arranged between the outer pane and the inner pane and a masking layer is arranged in a region between the outer pane and the inner pane;
b) providing a glass pane having an outer-side surface and an interior-side surface and a thickness of from 20 μm to 300 μm, wherein a reflective layer for reflecting light is arranged on the outer-side surface of the glass pane and/or on the interior-side surface of the glass pane;
c) joining the glass pane to the inner pane of the laminate via an adhesive layer to form a laminated pane such that the glass pane is arranged in a region of the laminated pane which, when looking perpendicularly through the laminated pane, lies entirely within the region in which the masking layer is arranged, wherein the adhesive layer is formed as an opaque adhesive layer or the adhesive layer is formed as an opaque adhesive layer or a colorless adhesive layer and an opaque layer is arranged between the adhesive layer and the glass pane so as to be immediately adjacent to the adhesive layer.

Steps a) and b) can be carried out in the order given, at the same time or in reverse. Step c) occurs after steps a) and b).

It should be understood that the external dimensions, i.e., the length and width, of the adhesive layer correspond to the external dimensions of the glass pane.

As explained above, the glass pane is arranged in a region of the laminated pane which, when viewed perpendicularly through the laminated pane, lies completely within the region in which the masking layer is arranged. Thus, the external dimensions of the glass pane are smaller than the outer pane and the inner pane of the laminated pane.

The provision of the glass pane in step b) can be carried out by applying a reflective layer to the entire interior-side surface and/or entire outer-side surface of an uncoated glass pane having the desired dimensions. To produce embodiments of laminated panes according to the invention in which an opaque layer is arranged between the adhesive layer and the glass pane so as to be immediately adjacent to the adhesive layer, in step b) an opaque layer is applied to the entire outer-side surface of the glass pane or, if a reflective layer is applied to the outer-side surface of the glass pane, to the entire reflective layer applied to the outer-side surface of the glass pane.

Alternatively, the provision of the glass pane in step b) can also be carried out by applying a reflective layer to the entire interior-side surface and/or the entire outer-side surface of an uncoated glass pane, which is larger than desired in terms of external dimensions, i.e., width and length, and then cutting out a portion having the desired dimensions from such a coated glass pane, for example by means of a laser cutting method. To produce embodiments of laminated panes according to the invention in which an opaque layer is arranged between the adhesive layer and the glass pane so as to be immediately adjacent to the adhesive layer, in step b) an opaque layer is additionally applied to the entire outer-side surface of the glass pane or, if a reflective layer is applied to the outer-side surface of the glass pane, to the entire reflective layer that is applied to the outer-side surface of the glass pane.

A reflective layer can be selectively arranged in a region of the laminated pane via the glass pane provided with the reflective layer.

The provision of the glass pane in step b) can additionally involve applying a protective layer to the reflective surface applied to the interior-side surface. The protective layer is preferably applied to the reflective layer by means of spraying, for example with a pressure atomizer.

If the laminated pane is to be curved, a curved outer pane and a curved inner pane are used when providing the laminate in step a). The glass pane comprising the reflective layer is flexible due to the small thickness of the glass pane and adapts to the curved inner pane of the laminate in step c). This is an advantage of the method according to the invention. With the method according to the invention, the coating with the reflective layer is carried out on a planar substrate.

The laminate can be provided in step a) using lamination methods familiar to those skilled in the art.

When providing the glass pane in step b), the reflective layer can be applied by means of generally known coating methods, such as magnetron sputtering or cold gas spraying.

The application of an opaque layer can be done, for example, by spray coating.

The preferred embodiments of the laminated pane according to the invention described above also correspondingly apply to methods for producing a laminated pane according to the invention.

The invention also relates to the use of a laminated pane according to the invention as a vehicle pane in a means of transport for traffic on land, in the air or on water, in particular in motor vehicles and in particular as a windshield for a head-up display.

In the following, the invention is explained in more detail with the aid of drawings and examples of embodiments. The drawings are schematic representations and are not true to scale. The drawings do not limit the invention in any way.

In the drawings:

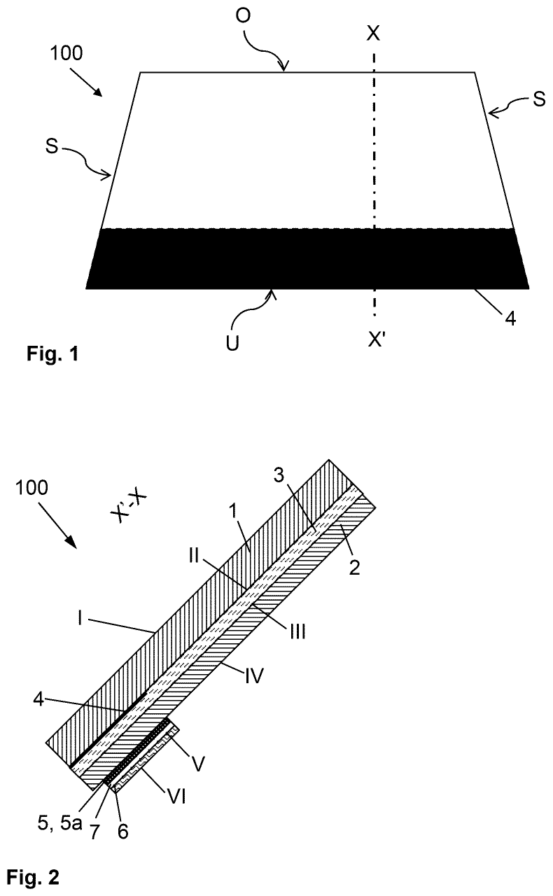

FIG. 1 shows a plan view of an embodiment of a laminated pane according to the invention,

FIG. 2 shows a cross section through the embodiment shown in FIG. 1,

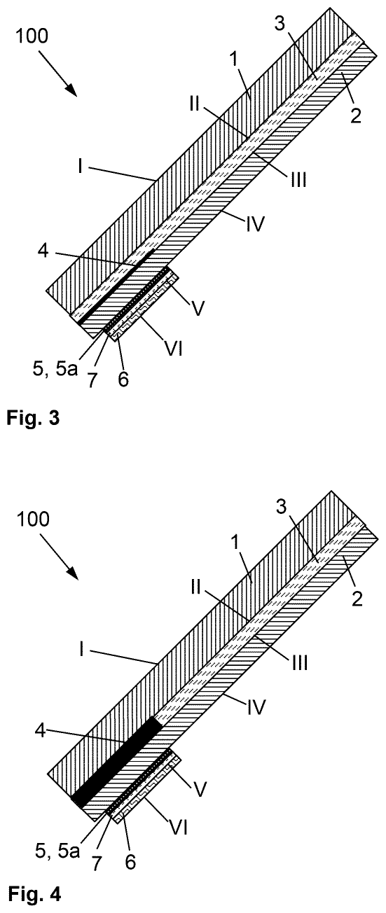

FIG. 3 shows a cross section through another embodiment of a laminated pane according to the invention,

FIG. 4 shows a cross section through another embodiment of a laminated pane according to the invention,

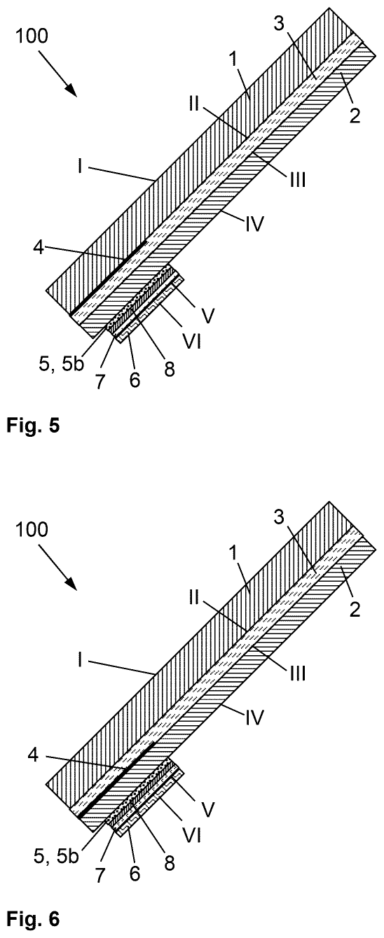

FIG. 5 shows a cross section through another embodiment of a laminated pane according to the invention,

FIG. 6 shows a cross section through another embodiment of a laminated pane according to the invention,

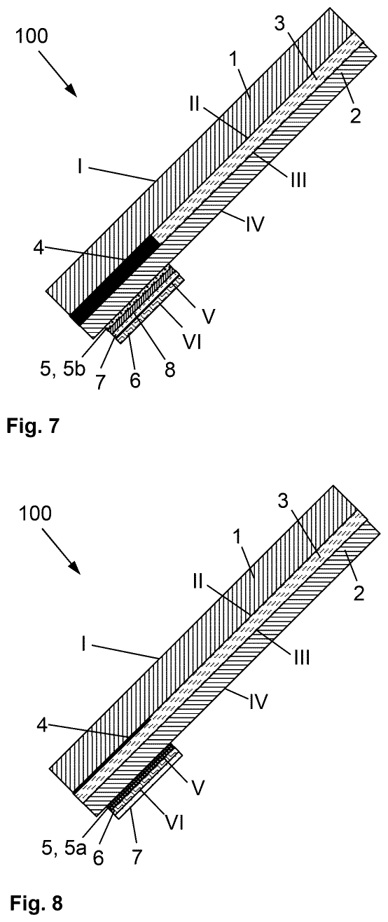

FIG. 7 shows a cross section through another embodiment of a laminated pane according to the invention,

FIG. 8 shows a cross section through another embodiment of a laminated pane according to the invention,

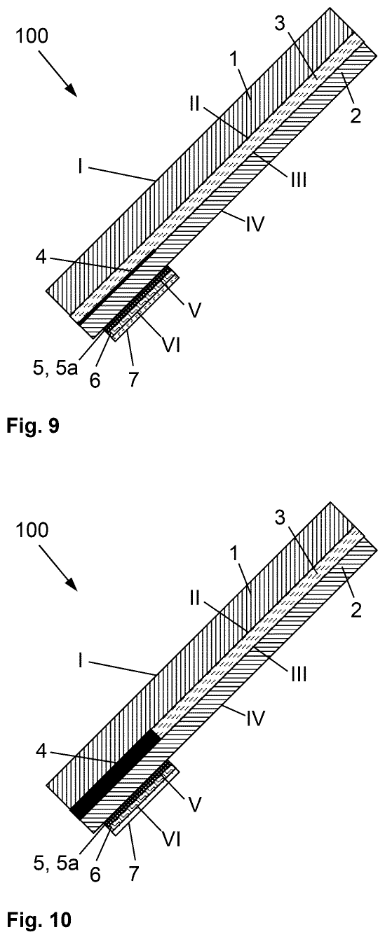

FIG. 9 shows a cross section through another embodiment of a laminated pane according to the invention,

FIG. 10 shows a cross section through another embodiment of a laminated pane according to the invention,

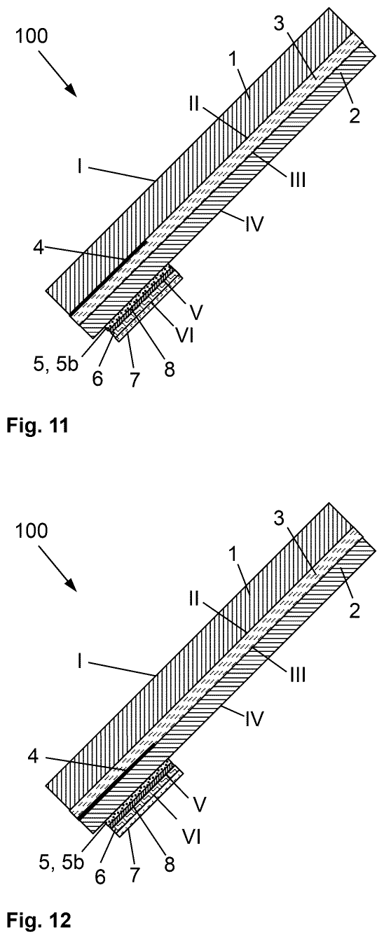

FIG. 11 shows a cross section through another embodiment of a laminated pane according to the invention,

FIG. 12 shows a cross section through another embodiment of a laminated pane according to the invention,

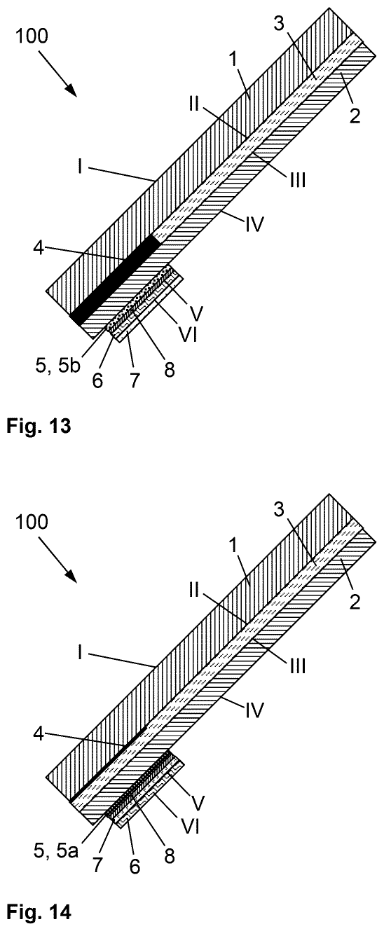

FIG. 13 shows a cross section through another embodiment of a laminated pane according to the invention,

FIG. 14 shows a cross section through another embodiment of a laminated pane according to the invention,

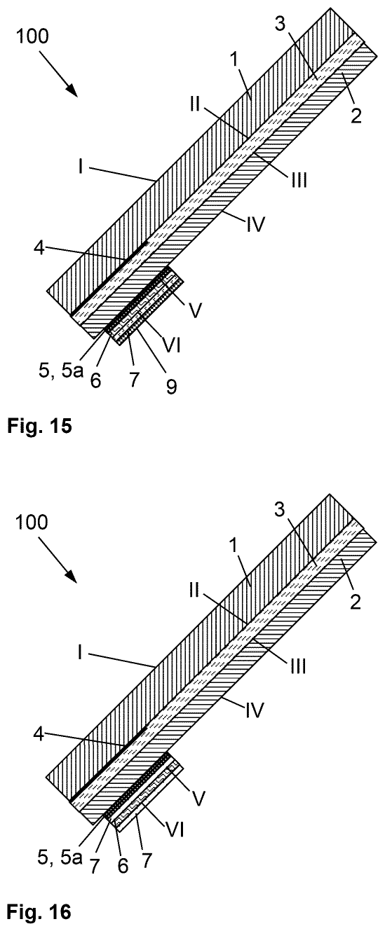

FIG. 15 shows a cross section through another embodiment of a laminated pane according to the invention,

FIG. 16 shows a cross section through another embodiment of a laminated pane according to the invention,

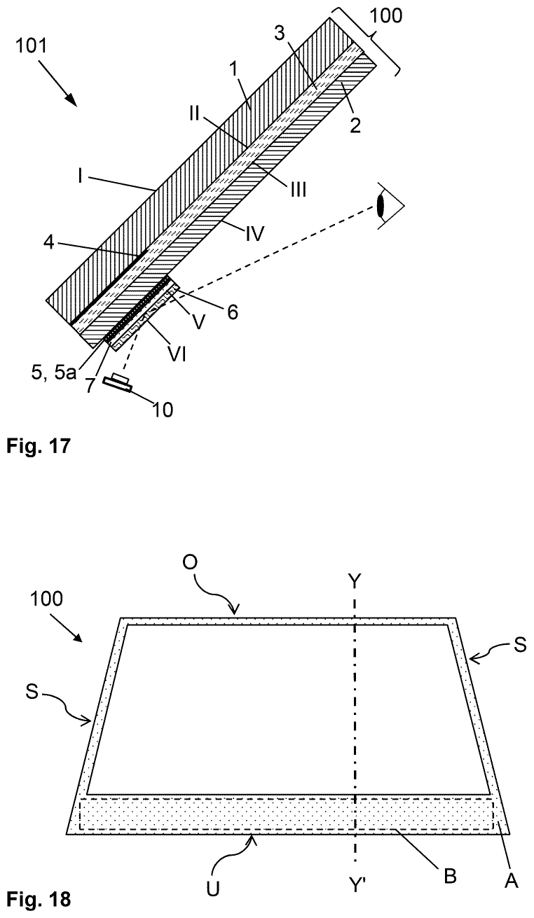

FIG. 17 shows a cross section through an embodiment of a projection arrangement according to the invention,

FIG. 18 is a plan view of another embodiment of a laminated pane according to the invention,

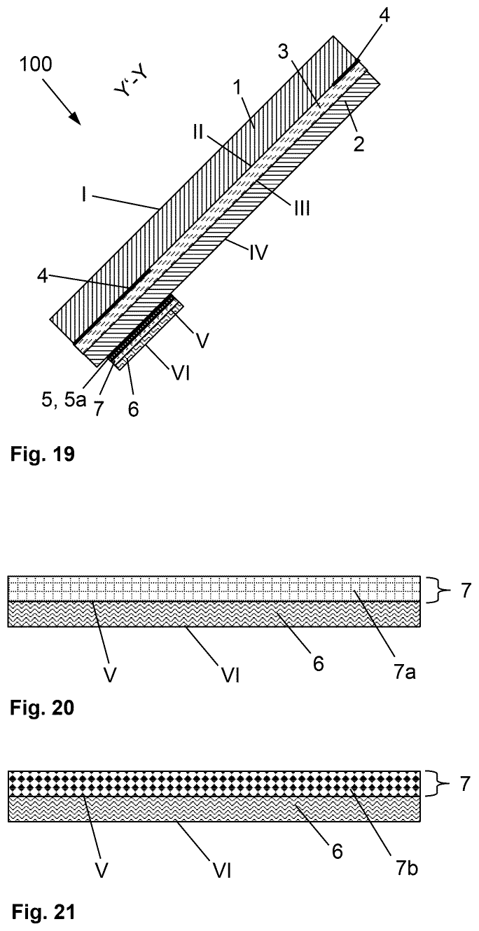

FIG. 19 shows a cross section through the embodiment shown in FIG. 18,

FIG. 20 shows a cross section through a coated glass pane,

FIG. 21 shows a cross section through another coated glass pane,

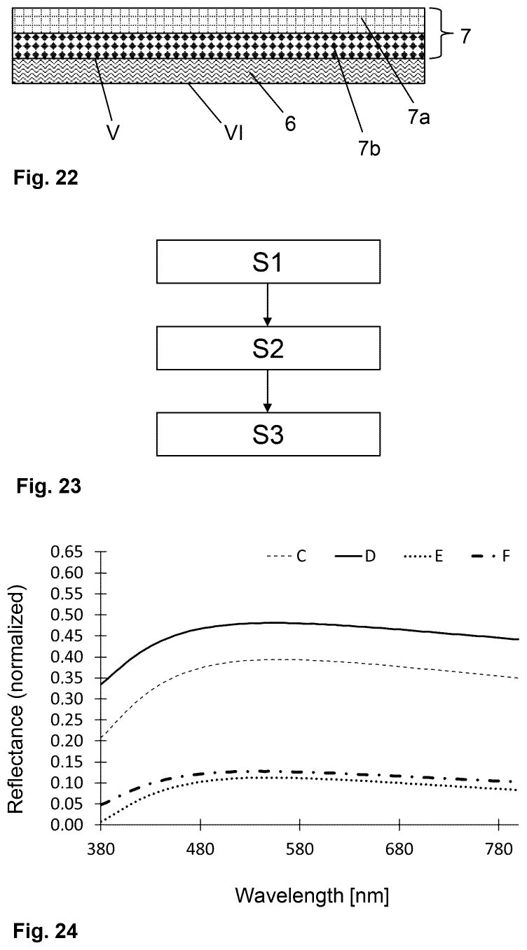

FIG. 22 shows a cross section through another coated glass pane,

FIG. 23 shows an embodiment of a method according to the invention by means of a flow chart,

FIG. 24 shows reflection spectra for an embodiment of a laminated pane according to the invention,

FIG. 25 shows reflection spectra for another embodiment of a laminated pane according to the invention, and

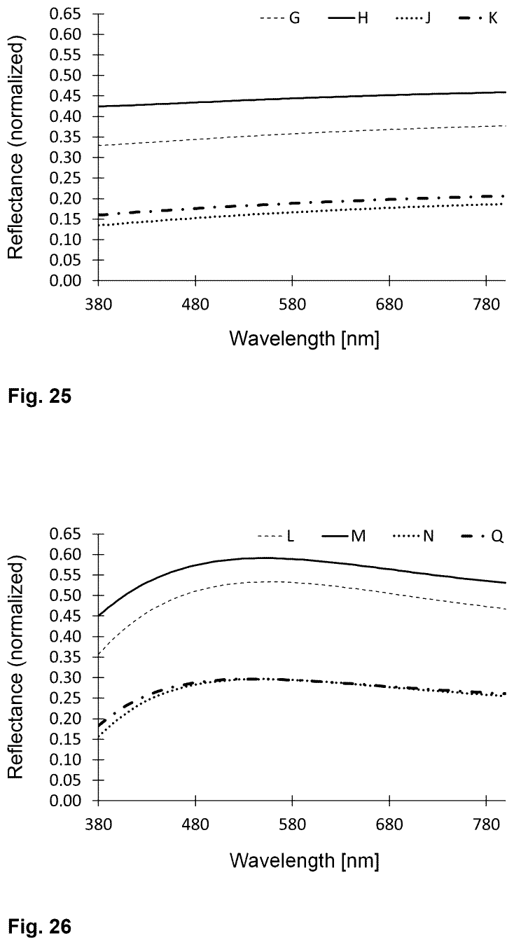

FIG. 26 shows reflection spectra for another embodiment of a laminated pane according to the invention.

FIG. 1 is a plan view of an embodiment of a laminated pane 100 according to the invention, and FIG. 2 shows the cross section through the laminated pane 100 shown in FIG. 1 along the section line X-X′. The laminated pane 100 shown in FIGS. 1 and 2 has an upper edge O, a lower edge U and two side edges S and comprises an outer pane 1 having an outer-side surface I and an interior-side surface II, an inner pane 2 having an outer-side surface III and an interior-side surface IV, a thermoplastic intermediate layer 3, a masking layer 4, an adhesive layer 5 and a glass pane 6 having an outer-side surface V and an interior-side surface VI. The thermoplastic intermediate layer 3 is arranged between the outer pane 1 and the inner pane 2, the inner pane 2 is arranged between the outer pane 1 and the glass pane 6, and the adhesive layer 5 is arranged between the inner pane 2 and the glass pane 6. The outer pane 1, the thermoplastic intermediate layer 3 and the inner pane 2 are arranged covering the entire surface of one another. The masking layer 4 is arranged in a region of the laminated pane 100 between the outer pane 1 and the inner pane 2. In the embodiment shown in FIGS. 1 and 2, the masking layer 4 is formed as an opaque masking print arranged on the interior-side surface II of the outer pane 1 and is arranged only in an edge region of the laminated pane 100 bordering on the lower edge U. The glass pane 6 is arranged in a region of the laminated pane 100 which, when viewed perpendicularly through the laminated pane 100, lies entirely in the region in which the masking layer 4 is arranged. The glass pane 6 is therefore smaller in terms of its external dimensions than the inner pane 2. In the embodiment shown in FIG. 2, a reflective layer 7 for reflecting light is arranged on the outer-side surface V of the glass pane 6. The outer-side surface V of the glass pane 6 with the reflective layer 7 arranged thereon is joined to the interior-side surface IV of the inner pane 2 via the adhesive layer 5.

The glass pane 6 is made, for example, of aluminum-silicate glass and has a thickness of 100 μm. The thermoplastic intermediate layer 3 contains PVB, for example, and has a thickness of 0.76 mm. The outer pane 1 consists, for example, of soda lime glass and is 2.1 mm thick. The inner pane 2 consists, for example, of soda lime glass and is 1.6 mm thick.

In the embodiment shown in FIG. 2, the adhesive layer 5 is formed as an opaque adhesive layer 5a and is, for example, an opaque adhesive.

The reflective layer 7 is, for example, a titanium dioxide layer with a thickness of 67 nm or a nickel-chromium layer with a thickness of 10 nm or a nickel-chromium layer with a thickness of 10 nm to which a titanium dioxide layer with a thickness of 67 nm is applied.

In the embodiment shown in FIGS. 1 and 2, the masking layer 4 extends between the two side edges S of the laminated pane 100 and, starting from the lower edge U of the laminated pane 100, has a width of, for example, 30 cm.

It should be understood that the laminated pane 100 can have any suitable geometric shape and/or curvature. Typically, the laminated pane 100 is a curved laminated pane.

FIG. 3 shows a cross section through another embodiment of a laminated pane 100 according to the invention. The embodiment shown in cross section in FIG. 3 only differs from that shown in FIG. 2 in that the masking layer 4 is not formed as an opaque masking print arranged on the interior-side surface II of the outer pane 1, but instead as an opaque masking print arranged on the outer-side surface III of the inner pane 2.

FIG. 4 shows a cross section through another embodiment of a laminated pane 100 according to the invention. The embodiment shown in cross section in FIG. 4 only differs from that shown in FIG. 2 in that the masking layer 4 is not formed as an opaque masking print arranged on the interior-side surface II of the outer pane 1, but instead is formed as an opaque region of the thermoplastic intermediate layer 3.

FIG. 5 shows a cross section through another embodiment of a laminated pane 100 according to the invention. The embodiment shown in cross section in FIG. 5 only differs from that shown in FIG. 2 in that the adhesive layer 5 is formed as a colorless adhesive layer 5b and an opaque layer 8 is arranged between the glass pane 6 and the adhesive layer 5 so as to be immediately adjacent to the adhesive layer 5. The adhesive layer 5 formed as a colorless adhesive layer 5b is, for example, an optical clear adhesive.

FIG. 6 shows a cross section through another embodiment of a laminated pane 100 according to the invention. The embodiment shown in cross section in FIG. 6 only differs from that shown in FIG. 5 in that the masking layer 4 is not formed as an opaque masking print arranged on the interior-side surface II of the outer pane 1, but instead as an opaque masking print arranged on the outer-side surface III of the inner pane 2.

FIG. 7 shows a cross section through another embodiment of a laminated pane 100 according to the invention. The embodiment shown in cross section in FIG. 7 only differs from that shown in FIG. 5 in that the masking layer 4 is not formed as an opaque masking print arranged on the interior-side surface II of the outer pane 1, but instead is formed as an opaque region of the thermoplastic intermediate layer 3.

FIG. 8 shows a cross section through another embodiment of a laminated pane 100 according to the invention. The embodiment shown in cross section in FIG. 8 only differs from that shown in FIG. 2 in that the reflective layer 7 is not arranged on the outer-side surface V of the glass pane 6, but on the interior-side surface VI of the glass pane 6. In the embodiment shown in FIG. 8, the outer-side surface V of the glass pane 6 is thus directly joined to the interior-side surface IV of the inner pane 2 via the adhesive layer 5.

FIG. 9 shows a cross section through another embodiment of a laminated pane 100 according to the invention. The embodiment shown in cross section in FIG. 9 only differs from that shown in FIG. 8 in that the masking layer 4 is not formed as an opaque masking print arranged on the interior-side surface II of the outer pane 1, but instead is formed as an opaque masking print arranged on the outer-side surface III of the inner pane 2.

FIG. 10 shows a cross section through another embodiment of a laminated pane 100 according to the invention. The embodiment shown in cross section in FIG. 10 only differs from that shown in FIG. 8 in that the masking layer 4 is not formed as an opaque masking print arranged on the interior-side surface II of the outer pane 1, but instead is formed as an opaque region of the thermoplastic intermediate layer 3.

FIG. 11 shows a cross section through another embodiment of a laminated pane 100 according to the invention. The embodiment shown in cross section in FIG. 11 only differs from that shown in FIG. 8 in that the adhesive layer 5 is formed as a colorless adhesive layer 5b and an opaque layer 8 is arranged between the glass pane 6 and the adhesive layer 5 so as to be immediately adjacent to the adhesive layer 5. The adhesive layer 5 formed as a colorless adhesive layer 5b is, for example, an optical clear adhesive.

FIG. 12 shows a cross section through another embodiment of a laminated pane 100 according to the invention. The embodiment shown in cross section in FIG. 12 only differs from that shown in FIG. 11 in that the masking layer 4 is not formed as an opaque masking print arranged on the interior-side surface II of the outer pane 1, but instead is formed as an opaque masking print arranged on the outer-side surface III of the inner pane 2.

FIG. 13 shows a cross section through another embodiment of a laminated pane 100 according to the invention. The embodiment shown in cross section in FIG. 13 only differs from that shown in FIG. 11 in that the masking layer 4 is not formed as an opaque masking print arranged on the interior-side surface II of the outer pane 1, but instead is formed as an opaque region of the thermoplastic intermediate layer 3.

FIG. 14 shows a cross section through another embodiment of a laminated pane 100 according to the invention. The embodiment shown in cross section in FIG. 14 only differs from that shown in FIG. 5 in that the adhesive layer 5 is formed as an opaque adhesive layer 5a.

It should be understood that the embodiments shown in FIGS. 6, 7, 11, 12 and 13 can also be modified such that the adhesive layer 5 is formed as an opaque adhesive layer 5a instead of as a colorless adhesive layer 5b.

FIG. 15 shows a cross section through another embodiment of a laminated pane 100 according to the invention. The embodiment shown in cross section in FIG. 15 only differs from that shown in FIG. 8 in that a protective layer 9 is additionally applied to the reflective layer 7 that is applied to the interior-side surface VI of the glass pane 6. The protective layer 9 is, for example, a polymer based on polyacrylates, polyoximes, alkyd resins, polyurethanes or mixtures thereof. The protective layer 9 has, for example, a thickness of 500 nm.

It should be understood that the embodiments shown in FIGS. 9 to 13 can also be modified such that a protective layer 9 is additionally applied to the reflective layer 7 applied to the interior-side surface VI of the glass pane 6.

FIG. 16 shows a cross section through another embodiment of a laminated pane 100 according to the invention. The embodiment shown in cross section in FIG. 16 only differs from that shown in FIG. 2 in that a reflective layer 7 is additionally applied to the interior-side surface VI of the glass pane 6. The reflective layer 7 applied to the interior-side surface VI of the glass pane 6 can be identical to or different than the reflective layer 7 applied to the outer-side surface V of the glass pane 6. Optionally, a protective layer 9 can be arranged in the direction of the vehicle interior on the reflective layer 7 applied to the interior-side surface VI of the glass pane 6.

It should be understood that the embodiments shown in FIGS. 3 to 7 and 14 can also be modified in such a way that a reflective layer 7 is additionally applied to the interior-side surface VI of the glass pane 6, on which reflective layer a protective layer 9 is optionally arranged.

FIG. 17 shows a cross section through an embodiment of a projection arrangement 101 according to the invention. The projection arrangement 101 shown in FIG. 16 comprises a laminated pane 100 and an imaging unit 10.

The laminated pane 100 is designed as shown in FIG. 2 and comprises an outer pane 1 having an outer-side surface I and an interior-side surface II, an inner pane 2 having an outer-side surface III and an interior-side surface IV, a thermoplastic intermediate layer 3, a masking layer 4, an adhesive layer 5 and a glass pane 6 having an outer-side surface V and an interior-side surface VI. The thermoplastic intermediate layer 3 is arranged between the outer pane 1 and the inner pane 2, the inner pane 2 is arranged between the outer pane 1 and the glass pane 6, and the adhesive layer 5 is arranged between the inner pane 2 and the glass pane 6. The outer pane 1, the thermoplastic intermediate layer 3 and the inner pane 2 are arranged covering the entire surface of one another. The masking layer 4 is arranged in a region of the laminated pane 100 between the outer pane 1 and the inner pane 2. The masking layer 4 is formed as an opaque masking print arranged on the interior-side surface II of the outer pane 1 and is arranged only in an edge region of the laminated pane 100 bordering on the lower edge U. The glass pane 6 is arranged in a region of the laminated pane 100 which, when viewed perpendicularly through the laminated pane 100, lies entirely in the region in which the masking layer 4 is arranged. The glass pane 6 is therefore smaller in terms of its external dimensions than the inner pane 2. In the embodiment shown in FIG. 17, a reflective layer 7 for reflecting light is arranged on the outer-side surface V of the glass pane 6. The outer-side surface V of the glass pane 6 with the reflective layer 7 arranged thereon is joined to the interior-side surface IV of the inner pane 2 via the adhesive layer 5.

The glass pane 6 is made, for example, of aluminum-silicate glass and has a thickness of 70 μm. The thermoplastic intermediate layer 3 contains PVB, for example, and has a thickness of 0.76 mm. The outer pane 1 consists, for example, of soda lime glass and is 2.1 mm thick. The inner pane 2 consists, for example, of soda lime glass and is 1.6 mm thick.

In the embodiment shown in FIG. 17, the adhesive layer 5 is formed as an opaque adhesive layer 5a and is, for example, an opaque adhesive.

The reflective layer 7 is, for example, a titanium dioxide layer with a thickness of 67 nm or a nickel-chromium layer with a thickness of 10 nm or a nickel-chromium layer with a thickness of 10 nm to which a titanium dioxide layer with a thickness of 67 nm is applied.

The laminated pane 100 is, for example, the windshield of a motor vehicle.

The projection arrangement 101 has an imaging unit 10. The imaging unit 10 is used to generate p-polarized light and s-polarized light (image information) or to generate circularly polarized light, which is directed toward the reflective layer 7 and is reflected into the vehicle interior by the reflective layer 7 as reflected light, where it can be perceived by a viewer, e.g., the driver. The reflective layer 7 is suitably designed to reflect the light from the imaging unit 10, i.e., an image formed by the light the imaging unit. The light preferably impinges on the reflective layer 7 at an angle of incidence of 55° to 80°, in particular of 62° to 77°. The imaging unit 10 is, for example, a display, in particular an LCD display. The imaging unit 10 preferably emits s-polarized radiation and p-polarized radiation in a ratio between 1:10 and 10:1 to one another. Optionally, the imaging unit 10 can have a λ/2 waveplate, by means of which the ratio of the s-polarized radiation and p-polarized radiation emitted by the imaging unit 10 can be varied. For example, the ratio can be varied on the basis of whether or not the driver is wearing polarization-selective sunglasses.

FIG. 18 is a plan view of another embodiment of a laminated pane 100 according to the invention, and FIG. 19 shows the cross section through the laminated pane 100 shown in FIG. 18 along the section line Y′-Y. The laminated pane 100 shown in FIGS. 18 and 19 has an upper edge O, a lower edge U and two side edges S and comprises an outer pane 1 having an outer-side surface I and an interior-side surface II, an inner pane 2 having an outer-side surface III and an interior-side surface IV, a thermoplastic intermediate layer 3, a masking layer 4, an adhesive layer 5 and a glass pane 6 having an outer-side surface V and an interior-side surface VI. The thermoplastic intermediate layer 3 is arranged between the outer pane 1 and the inner pane 2, the inner pane 2 is arranged between the outer pane 1 and the glass pane 6, and the adhesive layer 5 is arranged between the inner pane 2 and the glass pane 6. The outer pane 1, the thermoplastic intermediate layer 3 and the inner pane 2 are arranged covering the entire surface of one another. The masking layer 4 is arranged in a region of the laminated pane 100 between the outer pane 1 and the inner pane 2. The region in which the masking layer 4 is arranged is provided with the reference sign A. In the embodiment shown in FIGS. 18 and 19, the masking layer 4 is formed as an opaque cover print arranged on the interior-side surface II of the outer pane 1 and is arranged in a peripheral edge region which, in a portion that overlaps with the reflective layer 7, has a greater width than different portions than this portion. For ease of illustration, the masking layer in FIG. 18 is not shown in black, but is patterned. The glass pane 6 is arranged in a region of the laminated pane 100 which, when looking perpendicularly through the laminated pane 100, lies entirely in the region in which the masking layer 4 is arranged, and is provided with reference sign B in FIG. 18. The glass pane 6 is therefore smaller in terms of its external dimensions than the inner pane 2. In the embodiment shown in FIG. 19, a reflective layer 7 for reflecting light is arranged on the outer-side surface V of the glass pane 6. The outer-side surface V of the glass pane 6 with the reflective layer 7 arranged thereon is joined to the interior-side surface IV of the inner pane 2 via the adhesive layer 5.

The glass pane 6 is made, for example, of aluminum-silicate glass and has a thickness of 70 μm. The thermoplastic intermediate layer 3 contains PVB, for example, and has a thickness of 0.76 mm. The outer pane 1 consists, for example, of soda lime glass and is 2.1 mm thick. The inner pane 2 consists, for example, of soda lime glass and is 1.6 mm thick.

In the embodiment shown in FIG. 19, the adhesive layer 5 is formed as an opaque adhesive layer 5a and is, for example, an opaque adhesive. The reflective layer 7 is, for example, a titanium dioxide layer with a thickness of 67 nm or a nickel-chromium layer with a thickness of 10 nm or a nickel-chromium layer with a thickness of 10 nm to which a titanium dioxide layer with a thickness of 67 nm is applied.

It should be understood that the laminated pane 100 can have any suitable geometric shape and/or curvature. Typically, the laminated pane 100 is a curved laminated pane.

FIG. 20 shows a cross section of an embodiment of a coated glass pane 6. In the embodiment shown in FIG. 20, a reflective layer 7 in the form of a dielectric layer 7a is applied to the outer-side surface V of the glass pane 6. It should be understood that a reflective layer 7 can alternatively or additionally also be applied to the interior-side surface VI of the glass pane 6.

FIG. 21 shows a cross section of an embodiment of a coated glass pane 6. In the embodiment shown in FIG. 21, a reflective layer 7 in the form of a metal layer 7b is applied to the outer-side surface V of the glass pane 6. It should be understood that a reflective layer 7 can alternatively or additionally also be applied to the interior-side surface VI of the glass pane 6.

FIG. 22 shows a cross section of an embodiment of a coated glass pane 6. In the embodiment shown in FIG. 22, a reflective layer 7 in the form of a metal layer 7b with a dielectric layer 7a applied thereto is applied to the outer-side surface V of the glass pane 6. It should be understood that a reflective layer 7 can alternatively or additionally also be applied to the interior-side surface VI of the glass pane 6.

In embodiments in which a reflective layer 7 is applied to the glass pane 6 on both the outer-side surface V and the interior-side surface VI, the two reflective layers 7 can be identical or different.

An embodiment of a method according to the invention is shown in FIG. 23 by means of a flow chart.

In a first step, S1, a laminate composed of an outer pane 1 having an outer-side surface I and an interior-side surface II, a thermoplastic intermediate layer 3 and an inner pane 2 having an outer-side surface III and an interior-side surface IV, wherein the thermoplastic intermediate layer 3 is arranged between the outer pane 1 and the inner pane 2 and a masking layer 4 is arranged in a region between the outer pane 1 and the inner pane 2, is provided.

In a second step, S2, a glass pane 6 having an outer-side surface V and an interior-side surface VI and a thickness of 20 μm to 300 μm, wherein a reflective layer 7 for reflecting light is arranged on the outer-side surface V of the glass pane 6 and/or on the interior-side surface VI of the glass pane 6 is provided.

In a third step, S3, the glass pane 6 is joined to the inner pane 2 of the laminate via an adhesive layer 5 to form a laminated pane 100 such that the glass pane 6 is arranged in a region of the laminated pane 100 which, when looking perpendicularly through the laminated pane 100, lies entirely in the region in which the masking layer 4 is arranged, and wherein the adhesive layer 5 is formed as an opaque adhesive layer 5a or the adhesive layer 5 is formed as an opaque adhesive layer 5a or a colorless adhesive layer 5b, and an opaque layer 8 is arranged between the adhesive layer 5 and the glass pane 6 so as to be immediately adjacent to the adhesive layer 5.

Steps S1 and S2 can also be performed in reverse or at the same time.

The invention will be explained below with reference to examples. The reflective properties of different embodiments of laminated panes according to the invention for p-polarized light and for s-polarized light at an angle of incidence of 60° and at an angle of incidence of 70° are compared below.

The layer sequence and the layer thickness according to Examples 1, 2 and 3 are given in Tables 1, 2 to 3. In order to simulate a masking layer 4, a dark outer pane 1 and dark PVB as the thermoplastic intermediate layer 3 were used in the examples.

TABLE 1

| Material | Layer thickness | |
|---|---|---|
| Soda lime glass (tinted) | 2.1 | mm |
| PVB (tinted) | 0.76 | mm |
| Soda lime glass | 2.1 | mm |
| PVB (tinted) | 2.00 | mm |
| TiO₂ | 67 | nm |
| Thin glass | 100 | μm |

TABLE 2

| Material | Layer thickness | |
|---|---|---|
| Soda lime glass (tinted) | 2.1 | mm |
| PVB (tinted) | 0.76 | mm |
| Soda lime glass | 2.1 | mm |
| PVB (tinted) | 2.00 | mm |
| NiCr | 10 | nm |
| Thin glass | 100 | μm |

TABLE 3

| Material | Layer thickness | |
|---|---|---|
| Soda lime glass (tinted) | 2.1 | mm |
| PVB (tinted) | 0.76 | mm |
| Soda lime glass | 2.1 | mm |
| PVB (tinted) | 2.00 | mm |
| TiO₂ | 67 | nm |
| NiCr | 10 | nm |
| Thin glass | 100 | μm |

The reflectance describes the proportion of the total irradiated radiation that is reflected. It is given as a unitless number from 0 to 1 (normalized with respect to the irradiated radiation). It forms the reflection spectrum when plotted as a function of the wavelength. The statements regarding the reflectance relate to a reflection measurement using a source of light type A, which emits radiation in the spectral range of 380 nm to 800 nm with a normalized radiation intensity of 1.

FIG. 24 shows reflection spectra for an embodiment of a laminated pane 100 constructed as stated in Table 1. Reflection spectrum C shows the reflectance of the laminated pane 100 with respect to s-polarized radiation irradiated at an angle of incidence of 60° as a function of the wavelength in the spectral range from 380 nm to 800 nm. Reflection spectrum D shows the reflectance of the laminated pane 100 with respect to s-polarized radiation irradiated at an angle of incidence of 70° as a function of the wavelength in the spectral range from 380 nm to 800 nm. Reflection spectrum E shows the reflectance of the laminated pane 100 with respect to p-polarized radiation irradiated at an angle of incidence of 60° as a function of the wavelength in the spectral range from 380 nm to 800 nm. Reflection spectrum F shows the reflectance of the laminated pane 100 with respect to p-polarized radiation irradiated at an angle of incidence of 70° as a function of the wavelength in the spectral range from 380 nm to 800 nm.

It can be seen from FIG. 24 that the reflectance of a laminated pane 100 having the structure shown in Table 1 with respect to s-polarized radiation is on average 0.41 and is thus approximately four times as high as the average reflectance with respect to p-polarized radiation, which is on average 0.10. If the laminated pane 100 having the structure shown in Table 1 is irradiated with a mixture of s-polarized radiation and p-polarized radiation in a ratio of 1 to 1, an average reflectance of 0.26 is thus provided in the range from 380 nm to 800 nm.

FIG. 25 shows reflection spectra for an embodiment of a laminated pane 100 according to the invention, which is constructed as stated in Table 2. Reflection spectrum G shows the reflectance of the laminated pane 100 with respect to s-polarized radiation irradiated at an angle of incidence of 60° as a function of the wavelength in the spectral range from 380 nm to 800 nm. Reflection spectrum H shows the reflectance of the laminated pane 100 with respect to s-polarized radiation irradiated at an angle of incidence of 70° as a function of the wavelength in the spectral range from 380 nm to 800 nm. Reflection spectrum J shows the reflectance of the laminated pane 100 with respect to p-polarized radiation irradiated at an angle of incidence of 60° as a function of the wavelength in the spectral range from 380 nm to 800 nm. Reflection spectrum K shows the reflectance of the laminated pane 100 with respect to p-polarized radiation irradiated at an angle of incidence of 70° as a function of the wavelength in the spectral range from 380 nm to 800 nm.

It can be seen from FIG. 25 that the reflectance of a laminated pane 100 having the structure shown in Table 2 with respect to s-polarized radiation is on average 0.40 and is thus approximately twice as high as the average reflectance with respect to p-polarized radiation, which is on average 0.18. If the laminated pane 100 having the structure shown in Table 2 is irradiated with a mixture of s-polarized radiation and p-polarized radiation in a ratio of 1 to 1, an average reflectance of 0.29 is thus provided in the range from 380 nm to 800 nm.

FIG. 26 shows reflection spectra for an embodiment of a laminated pane 100 according to the invention, which is constructed as stated in Table 3. Reflection spectrum L shows the reflectance of the laminated pane 100 with respect to s-polarized radiation irradiated at an angle of incidence of 60° as a function of the wavelength in the spectral range from 380 nm to 800 nm. Reflection spectrum M shows the reflectance of the laminated pane 100 with respect to s-polarized radiation irradiated at an angle of incidence of 70° as a function of the wavelength in the spectral range from 380 nm to 800 nm. Reflection spectrum N shows the reflectance of the laminated pane 100 with respect to p-polarized radiation irradiated at an angle of incidence of 60° as a function of the wavelength in the spectral range from 380 nm to 800 nm. Reflection spectrum Q shows the reflectance of the laminated pane 100 with respect to p-polarized radiation irradiated at an angle of incidence of 70° as a function of the wavelength in the spectral range from 380 nm to 800 nm.

It can be seen from FIG. 26 that the reflectance of a laminated pane 100 having the structure shown in Table 3 with respect to s-polarized radiation is on average 0.53 and is thus approximately twice as high as the average reflectance with respect to p-polarized radiation, which is on average 0.27. If the laminated pane 100 having the structure shown in Table 3 is irradiated with a mixture of s-polarized radiation and p-polarized radiation in a ratio of 1 to 1, an average reflectance of 0.40 is thus provided in the range from 380 nm to 800 nm.

A comparison of FIGS. 24 to 26 demonstrates that a laminated pane 100 having a reflective layer 7 consisting of an NiCr layer and a TiO₂ layer applied to the NiCr layer has a higher reflectance with respect to s-polarized radiation and with respect to p-polarized radiation than a laminated pane 100 having a reflective layer 7 consisting of an NiCr layer and also has a higher reflectance with respect to s-polarized radiation and with respect to p-polarized radiation than a laminated pane 100 having a reflective layer 7 consisting of a TiO₂ layer.

### LIST OF REFERENCE SIGNS

100 Laminated pane
101 Projection arrangement
1 Outer pane
2 Inner pane
3 Thermoplastic intermediate layer
4 Masking layer
5 Adhesive layer
5a Opaque adhesive layer
5b Colorless adhesive layer
6 Glass pane
7 Reflective layer
7a Dielectric layer
7b Metal layer
8 Opaque layer
9 Protective layer
10 Imaging unit
O Upper edge of the laminated pane 100
U Lower edge of the laminated pane 100
S Side edge of the laminated pane 100
I Outer-side surface of the outer pane 1
II Interior-side surface of the outer pane 1
III Outer-side surface of the inner pane 2
IV Interior-side surface of the inner pane 2
V Outer-side surface of the glass pane 6
VI Interior-side surface of the glass pane 6
A Region in which the masking layer 4 is arranged
B Region in which the glass pane 6 is arranged
X′-X Section line
Y′-Y Section line

1. A laminated pane, comprising:
an outer pane having an outer-side surface and an interior-side surface,
a thermoplastic intermediate layer,
an inner pane having an outer-side surface and an interior-side surface,
a masking layer,
an adhesive layer,
a glass pane having an outer-side surface and an interior-side surface and a thickness of 20 μm to 300 μm,
wherein the thermoplastic intermediate layer is arranged between the outer pane and the inner pane,
the masking layer is arranged between the outer pane and the inner pane in a region of the laminated pane,
the adhesive layer is arranged between the inner pane and the glass pane,
a reflective layer for reflecting light is arranged on the outer-side surface of the glass pane and/or on the interior-side surface of the glass pane,
the glass pane is arranged in a region of the laminated pane which, in a perpendicular view through the laminated pane, lies entirely in the region in which the masking layer is arranged;
and wherein the adhesive layer is formed as an opaque adhesive layer or the adhesive layer is formed as an opaque adhesive layer or a colorless adhesive layer and an opaque layer is arranged between the adhesive layer and the glass pane so as to be immediately adjacent to the adhesive layer.

2. The laminated pane according to claim 1, wherein the glass pane has a thickness of from 50 μm to 200 μm.

3. The laminated pane according to claim 1, wherein the reflective layer reflects at least 10% of visible light.

4. The laminated pane according to claim 1, wherein the reflective layer contains or consists of a dielectric layer and/or a metal layer.

5. The laminated pane according to claim 4, wherein the dielectric layer is a layer made up of one or more layers and has or consists of at least one highly refractive layer with a refractive index greater than 1.9.

6. The laminated pane according to claim 5, wherein the dielectric layer has a thickness of from 1 nm to 120 nm.

7. The laminated pane according to claim 4, wherein the metal layer contains or consists of at least one metal selected from a group consisting of zirconium, hafnium, silver, gold, nickel, chromium, molybdenum, tungsten, copper, vanadium, niobium, tantalum, palladium, platinum, titanium, zinc, tin or aluminum or alloys thereof.

8. The laminated pane according to claim 7, wherein the metal layer has a thickness of from 1 nm to 100 nm.

9. The laminated pane according to claim 1, wherein the reflective layer is arranged on the outer-side surface of the glass pane.

10. The laminated pane according to claim 1, wherein the masking layer is formed as an opaque masking print arranged on the interior-side surface of the outer pane or the outer-side surface of the inner pane or is formed as an opaque region of the thermoplastic intermediate layer.

11. A projection arrangement comprising:
a laminated pane according to claim 1,
an imaging unit directed at the reflective layer.

12. The projection arrangement according to claim 11, wherein the imaging unit emits s-polarized radiation and p-polarized radiation in a ratio between 1:10 and 10:1 to one another or the imaging unit emits circularly polarized radiation.

13. The projection arrangement according to claim 12, wherein the imaging unit has a λ/2 waveplate, by means of which the ratio of the s-polarized radiation and p-polarized radiation emitted by the imaging unit is variable.

14. A method for producing a laminated pane according to claim 1, comprising:
a) providing a laminate consisting of an outer pane having an outer-side surface and an interior-side surface, a thermoplastic intermediate layer and an inner pane having an outer-side surface and an interior-side surface, wherein the thermoplastic intermediate layer is arranged between the outer pane and the inner pane and a masking layer is arranged in a region between the outer pane and the inner pane;
b) providing a glass pane having an outer-side surface and an interior-side surface and a thickness of from 20 μm to 300 μm, wherein a reflective layer for reflecting light is arranged on the outer-side surface of the glass pane and/or on the interior-side surface of the glass pane;
c) joining the glass pane to the inner pane of the laminate via an adhesive layer to form a laminated pane such that the glass pane is arranged in a region of the laminated pane which, when looking perpendicularly through the laminated pane, lies entirely within the region in which the masking layer is arranged,
wherein the adhesive layer is formed as an opaque adhesive layer or the adhesive layer is formed as an opaque adhesive layer or a colorless adhesive layer and an opaque layer is arranged between the adhesive layer and the glass pane so as to be immediately adjacent to the adhesive layer.

15. A method comprising providing a laminated pane according to claim 1 as a vehicle window in modes of transport for traffic on land, in the air or on water.

16. The laminated pane according to claim 2, wherein the glass pane has a thickness of from 50 μm to 100 μm.

17. The laminated pane according to claim 3, wherein the reflective layer reflects at least 25% of visible light.

18. The laminated pane according to claim 6, wherein the dielectric layer has a thickness of from 40 nm to 80 nm.

19. The laminated pane according to claim 8, wherein the metal layer has a thickness of from 5 nm to 50 nm.

20. The method according to claim 15, wherein the laminated pane is a windshield for a head-up display.
